(19) United States
(12) Patent Application Publication
(10) Pub. No.: US 2025/0038869 A1
(43) Pub. Date: Jan. 30, 2025

(54) TIME SYNCHRONIZATION SYSTEM, TIME VERIFICATION DEVICE, AND TIME VERIFICATION METHOD

(71) Applicant: DENSO CORPORATION, Kariya-city (JP)

(72) Inventors: Yasuhiro KOTANI, Kariya-city (JP); Takao HASEGAWA, Kariya-city (JP)

(21) Appl. No.: 18/910,793

(22) Filed: Oct. 9, 2024

Related U.S. Application Data
(63) Continuation of application No. PCT/JP2023/016347, filed on Apr. 25, 2023.

(30) Foreign Application Priority Data
Apr. 28, 2022 (JP) 2022-074975

(51) Int. Cl. H04J 3/06

(52) U.S. Cl. CPC H04J 3/0644; H04J 3/0667

(57) ABSTRACT

A time verification device comprises a verification execution unit and a result transmission unit. The verification execution unit generates verification information for verifying a synchronization state of a local time and a global time for each of one or more slave devices on the basis of master verification information received from a master device and slave verification information received from each of the one or more slave devices. The result transmission unit transmits the verification information generated by the verification execution unit to each of the master device and the one or more slave devices.

### CROSS REFERENCE TO RELATED APPLICATION

The present application is a continuation application of International Patent Application No. PCT/JP2023/016347 filed on Apr. 25, 2023, which designated the U.S. and claims the benefit of priority from Japanese Patent Application No. 2022-074975 filed on Apr. 28, 2022. The entire disclosures of all of the above applications are incorporated herein by reference.

### TECHNICAL FIELD

The present disclosure relates to a technique for verifying time synchronization of each node in a network.

### BACKGROUND

As a time synchronization protocol using Ethernet, there is known a technique in which a master node distributes its own time to a slave node in a time synchronization system to synchronize the time of the slave node with the time of the master node. Ethernet is a registered trademark.

In the time synchronization system, The slave node may be synchronized with an unintended time due to corruption or tampering of time information. To detect such an anomaly, for example, a related art describes a technique in which, after a plurality of receptions of a time synchronization message, the state of a time synchronization network is estimated from the message content to detect an anomaly.

### SUMMARY

A time synchronization system includes: a master device; one or more slave devices; and a time verification device, which are connected via a communication network. The master device is configured to repeatedly transmit to each of the one or more slave devices, and configured to transmit master verification information including a transmission time of the synchronization message to the time verification device. The slave device is configured to perform time synchronization to synchronize a time indicated by a local time counted by a clock of the slave device with a time indicated by the global time, and configured to transmit slave verification information including information used for time synchronization to the time verification device. The time verification device is configured to generate, for each of the slave devices, verification information for verifying a synchronization state between the local time and the global time, based on the master verification information received from the master device and the slave verification information received from each of the one or more slave devices, and configured to transmit the verification information to the master device and each of the one or more slave devices.

### BRIEF DESCRIPTION OF DRAWINGS

FIG. 1 is a block diagram illustrating a configuration of a time synchronization system.

FIG. 2 is a sequence diagram illustrating an overview of time synchronization and time verification.

FIG. 3 is an explanatory diagram illustrating a time synchronization method.

FIG. 4 is a list indicating the contents of a timesync master timing record (TMTR) table provided in a master electronic control unit (ECU).

FIG. 5 is a list indicating the contents of a timesync slave timing record (TSTR) table provided in a bridge ECU and a slave ECU.

FIG. 6 is an explanatory diagram of parameters used for time synchronization and time verification.

FIG. 7 is a list indicating the contents of a synchronized time base record (STBR) table provided in the bridge ECU and the slave ECU.

FIG. 8 is a list indicating the contents of a validate data (VD) table provided in a time verification ECU.

FIG. 9 is a flowchart of a master time process.

FIG. 10 is a flowchart of a bridge time process.

FIG. 11 is a flowchart of a slave time process.

FIG. 12 is a flowchart of a time verification process.

FIG. 13 is a flowchart of a modification of the time verification process.

FIG. 14 is a flowchart of a modification of the time verification process.

FIG. 15 is a block diagram illustrating another configuration example of the time synchronization system.

FIG. 16 is a block diagram illustrating another configuration example of the time synchronization system.

FIG. 17 is an explanatory diagram illustrating information included in a message used for time synchronization and time verification.

FIG. 18 is a flowchart of a verification confirmation process according to a first embodiment.

FIG. 19 is a flowchart of the verification confirmation process according to a second embodiment.

FIG. 20 is a flowchart of a master time process according to a third embodiment.

FIG. 21 is a flowchart of a condition satisfaction determination process according to the third embodiment.

### DETAILED DESCRIPTION

As a time synchronization protocol using Ethernet, there is known a technique in which a master node distributes its own time to a slave node in a time synchronization system to synchronize the time of the slave node with the time of the master node. Ethernet is a registered trademark.

In the time synchronization system, The slave node may be synchronized with an unintended time due to corruption or tampering of time information.

However, the related art requires a plurality of receptions of a time synchronization message in a state where an anomaly has occurred, leading to a problem in that it takes time before the anomaly is detected.

One aspect of the present disclosure provides a technique for rapidly verifying the time synchronization state of each node belonging to a time synchronization system.

One aspect of the present disclosure is a time synchronization system comprising a master device, one or more slave devices, and a time verification device. The master device, the one or more slave devices, and the time verification device are connected via a communication network.

The master device includes a synchronization message transmission unit configured to repeatedly transmit to each of the one or more slave devices, a synchronization message including a transmission time indicated by a global time counted by a clock of the master device, and a master information transmission unit configured to transmit master verification information including a transmission time of the synchronization message to the time verification device.

The slave device includes a synchronization execution unit configured to perform time synchronization to synchronize a time indicated by a local time counted by a clock of the slave device with a time indicated by the global time, based on information obtained by receiving the synchronization message, and a slave information transmission unit configured to transmit slave verification information including information used for time synchronization by the synchronization execution unit to the time verification device.

The time verification device includes a verification execution unit that generates, for each of the slave devices, verification information for verifying a synchronization state between the local time and the global time, based on the master verification information received from the master device and the slave verification information received from each of the one or more slave devices, and a result transmission unit configured to transmit the verification information generated by the verification execution unit to the master device and each of the one or more slave devices.

According to such a configuration, the one or more slave devices can rapidly determine the time synchronization state of the local time in the own device with respect to the global time, using the verification information.

A time verification device according to one aspect of the present disclosure is used in a time synchronization system. The time synchronization system includes a master device and one or more slave devices connected via a communication network and is configured to perform time synchronization to synchronize a time indicated by a local time counted by a clock of each of the one or more slave devices with a time indicated by a global time counted by a clock of the master device.

The time verification device comprises a verification execution unit that generates, for each of the slave devices, verification information for verifying a synchronization state between the local time and the global time, based on master verification information received from the master device and slave verification information received from each of the one or more slave devices, and a result transmission unit configured to transmit the verification information generated by the verification execution unit to each of the one or more slave devices. The master verification information includes a transmission time of a synchronization message indicated by the global time. The slave verification information is obtained by receiving the synchronization message and includes information used for the time synchronization.

According to such a configuration, it is possible to rapidly verify time synchronization in the time synchronization system.

A time verification method according to one aspect of the present disclosure is used in a time synchronization system. The time synchronization system includes a master device, one or more slave devices, and a time verification device connected via a communication network.

The master device repeatedly transmits to each of the one or more slave devices, a synchronization message including a transmission time indicated by a global time counted by a clock of the master device, and transmits master verification information including a transmission time of the synchronization message to the time verification device.

The slave device performs time synchronization to synchronize a time indicated by a local time counted by a clock of the slave device with a time indicated by the global time, based on information obtained by receiving the synchronization message, and transmits slave verification information including information used for the time synchronization to the time verification device.

The time verification device generates, for each of the slave devices, verification information for verifying a synchronization state between the local time and the global time, based on the master verification information received from the master device and the slave verification information received from each of the one or more slave devices, and transmits the verification information generated to each of the one or more slave devices.

According to such a method, it is possible to rapidly verify time synchronization in the time synchronization system.

In the following, embodiments of the present disclosure will be described with reference to the drawings.

### 1. First Embodiment

### (1-1. Configuration)

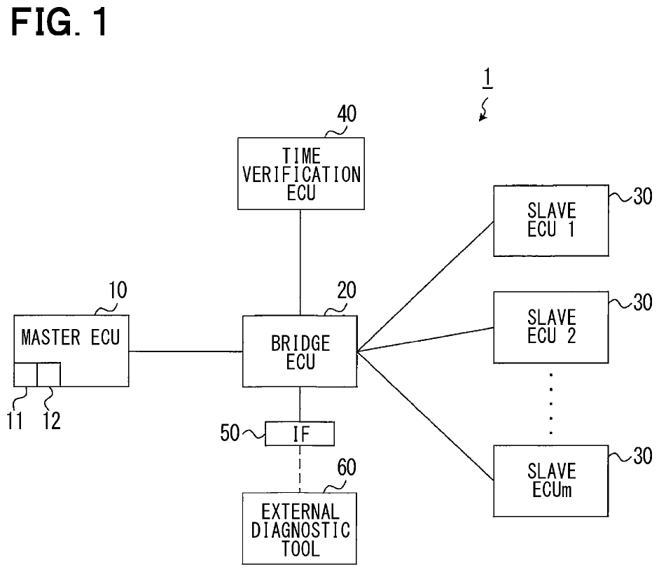

A time synchronization system 1 illustrated in FIG. 1 is a communication network formed of in-vehicle devices, and includes a master electronic control unit (hereinafter, master ECU) 10, a bridge ECU 20, a plurality of slave ECUs 30, and a time verification ECU 40. The bridge ECU 20 includes a relay device such as an Ethernet switch or a gateway.

The time synchronization system 1 may include an external device interface 50 for connecting an external diagnostic tool 60. In the present embodiment, the external device interface 50 is connected to the bridge ECU 20. For example, a USB connector may be used as the external device interface 50.

The master ECU 10, the plurality of slave ECUs 30, and the time verification ECU 40 are connected to the bridge ECU 20 via individual signal lines. That is, the master ECU 10, the plurality of slave ECUs 30, and the time verification ECU 40 form a star-shaped network with the bridge ECU 20 at the center. An Ethernet communication protocol is used for communication between each ECU 10 to 40 via the signal line. Ethernet is a registered trademark. The communication protocol is not limited to Ethernet, and may be a communication protocol such as a controller area network (CAN) or FlexRay. CAN and FlexRay are registered trademarks.

The time synchronization system 1 performs time synchronization to synchronize the local times used by the bridge ECU 20 and each of the plurality of slave ECUs 30 with the global time used by the master ECU 10. For the time synchronization, for example, IEEE1588 precision time protocol (hereinafter, PTP) may be used.

The bridge ECU 20 provides the external diagnostic tool 60 with information transmitted to and received from each of the ECUs 10 to 40 for the time synchronization and time verification in response to a request from the external diagnostic tool 60 connected to the external device interface 50.

The master ECU 10 is an electronic control device mainly including a microcomputer equipped with a central processing unit (CPU) 11 and memory 12 such as read-only memory ROM and random-access memory (RAM). Various functions of the microcomputer are each implemented by the CPU 11 executing a program stored in a non-transitory tangible recording medium. In this example, the ROM corresponds to a non-transitory tangible recording medium storing a program. By executing the program, a method corresponding to the program is executed. Some or all of the functions executed by the CPU may be configured as hardware by one or more integrated circuits (ICs) or the like. The number of microcomputers constituting the master ECU 10 may be one or more. The configurations of the bridge ECU 20, the slave ECU 30, and the time verification ECU 40 are similar to that of the master ECU 10. Hereinafter, the master ECU 10, the bridge ECU 20, the slave ECU 30, and the time verification ECU 40 will be collectively referred to as each of the ECUs 10 to 40.

### (1-2. Overview of Time Synchronization)

An overview of the time synchronization performed by the time synchronization system 1 will be described.

Each of the ECUs 10 to 30 to be subjected to time synchronization includes a local clock that operates independently.

In the master ECU 10, the master local time and the global time are used. Both the master local time and the global time are timed in accordance with the local clock of the master ECU 10. The master local time indicates a unique time in the master ECU 10 and is used for measuring a time interval and the like. The global time may indicate a time different from the master local time.

The bridge ECU 20 and the plurality of slave ECUs 30 each use the slave local time and the synchronization local time. Both the slave local time and the synchronization local time are timed in accordance with the local clock of each of the ECUs 20, 30. The slave local time indicates a unique time in the bridge ECU 20 and each of the plurality of slave ECUs 30 and is used for measuring a time interval and the like. The synchronization local time may indicate a time different from the slave local time.

The time synchronization means that in the bridge ECU 20 and each of the plurality of slave ECUs 30, the time indicated by the synchronization local time is aligned with the time indicated by the global time of master ECU 10. An application that uses the time executed by each of the ECUs 10 to 30 uses the global time or the time indicated by the synchronization local time synchronized with the global time.

Each of the ECUs 10 to 30 stores delay information PD that is set based on a transmission delay time between the master ECU 10 and the bridge ECU 20 (hereinafter, MB delay time) and a transmission delay time between each slave ECU 30 and the bridge ECU 20 (hereinafter, SB delay time). The delay information PD may be a value measured at the time of shipment or the like (i.e., a fixed value), or may be a value measured in accordance with a determined procedure at a determined timing such as at the time of system activation (i.e., a variable value).

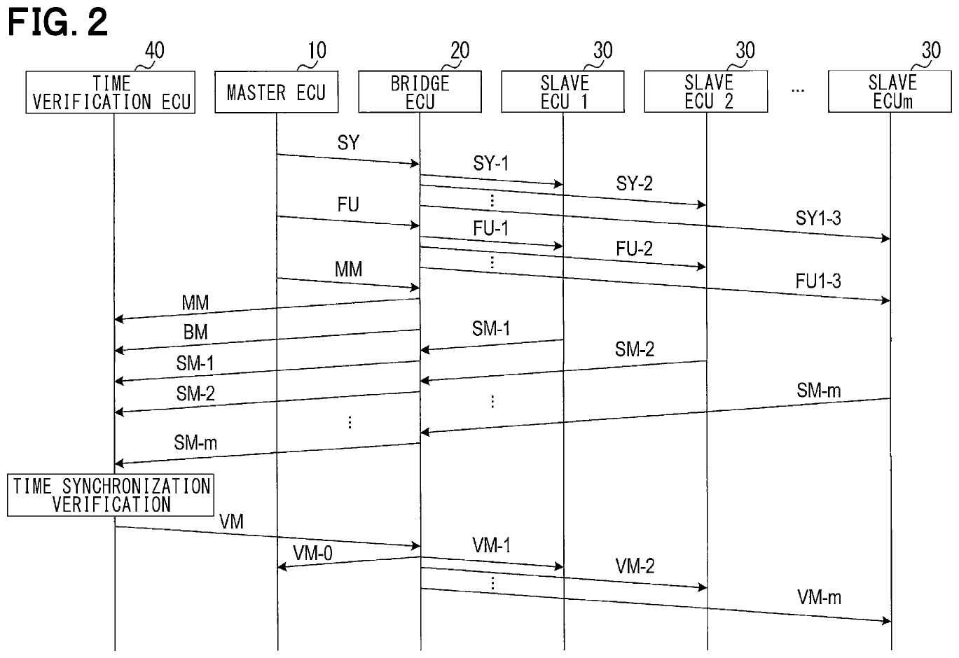

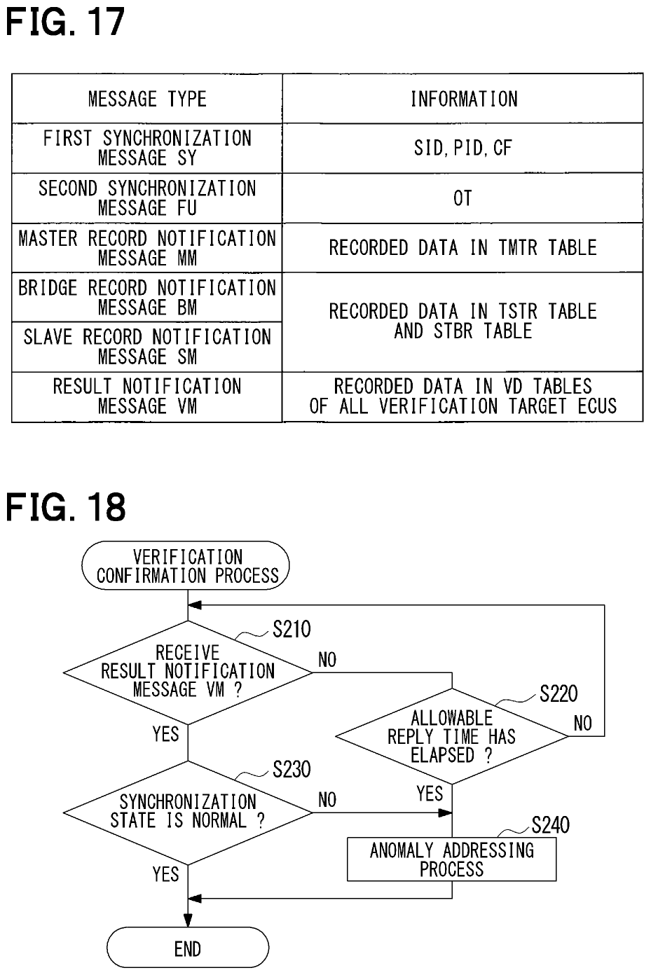

As illustrated in FIGS. 2 and 17, a first synchronization message SY and a second synchronization message FU are used in the time synchronization. In the time verification, a master record notification message MM, a bridge record notification message BM, a slave record notification message SM, and a result notification message VM are used. All of these messages SY, FU, MM, BM, SM, VM are messages handled at the application layer of the Transmission Control Protocol/Internet Protocol (TCP/IP) model, and communication is performed using TCP or UDP.

The master ECU 10 periodically transmits the first synchronization message SY to the bridge ECU 20. The master ECU 10 transmits the second synchronization message FU subsequent to the first synchronization message SY. A global transmission time OT, which is called a follow-up message and is time information accurately representing the transmission time of the first synchronization message SY in nanoseconds based on the global time, is added to the second synchronization message FU.

The master ECU 10 may transmit the first synchronization message SY to the bridge ECU 20 at the timing when a preset first transmission condition is satisfied, and thereafter, may periodically transmit the first synchronization message SY. The first transmission condition may include the activation of the master ECU 10 or the elapse of a predetermined time after the activation of the master ECU 10. The first transmission condition may include the turning on of the power source, ignition (hereinafter, IG), or accessory (hereinafter, ACC) of the vehicle, and the elapse of a predetermined time after the turning on of the power source, IG, or ACC. Moreover, the first transmission condition may include, in addition to the first transmission condition described above, that the master ECU 10 confirms the activation of the bridge ECU 20, which receive the first synchronization message SY, and the slave ECU 30.

The master ECU 10 may determine whether or not the bridge ECU 20 and the slave ECU 30 have been activated based on, for example, whether or not a predetermined frame from the slave ECU 30 has been received via the bridge ECU. The transmission interval of the first synchronization message SY, which is transmitted periodically, does not need to be permanently constant, and the master ECU 10 may control the transmission interval based on the result of time synchronization verification to be described later.

Upon receiving the first synchronization message SY, the bridge ECU 20 transfers the first synchronization message SY to each of the plurality of slave ECUs 30. Here, the number of slave ECUs 30 is m. The bridge ECU 20 adds a residence delay time CF to each of first synchronization messages SY-1 to SY-m that are transferred to the slave ECUs 30. The residence delay time CF is a measurement of the time required for the bridge ECU 20 to transmit the first synchronization messages SY-1 to SY-m to the respective slave ECUs 30 after receiving the first synchronization message SY from the master ECU 10.

Upon receiving the second synchronization message FU, the bridge ECU 20 transfers the second synchronization message FU to each of the m slave ECUs 30.

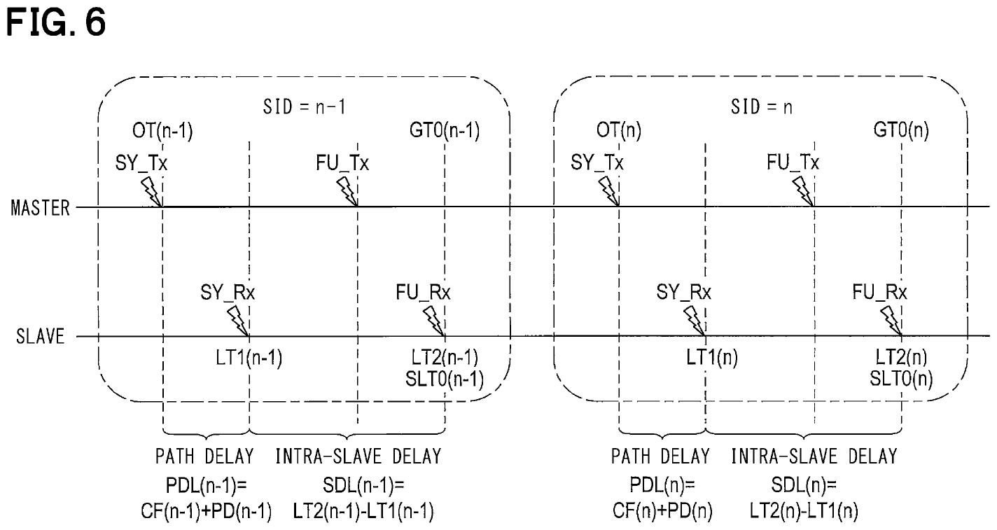

As illustrated in FIG. 6, upon receiving the first synchronization message SY, the bridge ECU 20 and each slave ECU 30 acquire a first local reception time LT1, which is a time stamp representing a reception time. When the second synchronization message FU is received, a second local reception time LT2, which is a time stamp representing a reception time, is acquired. Both the first local reception time LT1 and the second local reception time LT2 are time information accurately representing the reception time in nanoseconds based on the slave local time.

The bridge ECU 20 and each slave ECU 30 perform time synchronization using information obtained by receiving the first synchronization message SY and the second synchronization message FU.

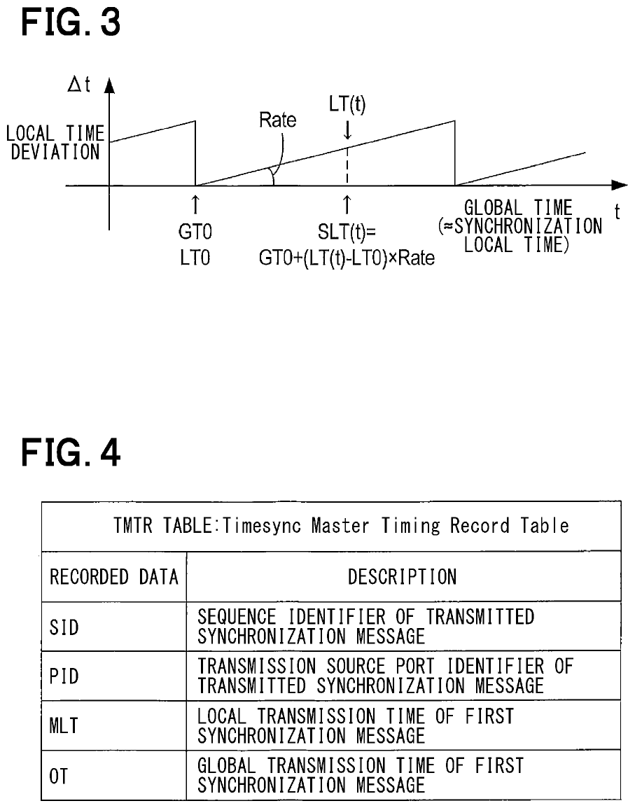

As illustrated in FIG. 3, since the global time and the synchronized slave time differ from each other in the local clock to be used, the time deviation increases with the elapse of time even if the times are aligned and the operation is then performed. Therefore, in the time synchronization, a reference global time GT0 and a rate correction value Rate are calculated in accordance with the information obtained by receiving the first synchronization message SY and the second synchronization message FU, and a time SLT(t) represented by the synchronization local time is calculated in accordance with Equation (1).

$$\begin{matrix}( Mathematical Formula 1 ) & \\ SLT ( t ) = GT 0 + Rate \times \{ LT ( t ) - LT 0 \} & ( 1 )\end{matrix}$$

The reference global time GT0 is a time that, according to the global time, represents the timing at which the synchronization local time is aligned with the global time. In FIG. 3, the reference global time GT0 is a time at which the global time and the synchronized slave time coincide.

The rate correction value Rate is the amount of increase per unit time in the deviation between the time represented by the global time and the time represented by the synchronized slave time. In FIG. 3, the rate correction value Rate corresponds to the slope of the line representing the synchronized slave time with respect to the line representing the global time.

LT(t) is the current time represented by the slave local time, and LT0 is the reference global time GT0 represented by the slave local time.

### (1-3. Overview of Time Verification)

An overview of the time verification performed by the time synchronization system 1 will be described.

To perform time verification, each of the ECUs 10 to 30 records information related to time synchronization in a table. As illustrated in FIG. 2, after transmitting the second synchronization message FU, the master ECU 10 transmits the master record notification message MM including the information recorded in the table (hereinafter, time record information) to the time verification ECU 40 via the bridge ECU 20. After transferring the second synchronization message FU, the bridge ECU 20 transmits the bridge record notification message BM including the time record information to the time verification ECU 40. After receiving the second synchronization messages FU, the respective slave ECUs 30 transmit slave record notification messages SM-1 to SM-m, including the time record information, to the time verification ECU 40 via the bridge ECU 20. Hereinafter, when the slave record notification messages SM-1 to SM-m are described without distinction, these messages are referred to as slave record notification messages SM.

The master ECU 10 transmits the master record notification message MM to the time verification ECU 40 via the bridge ECU 20 at the timing when a preset second transmission condition is satisfied. The second transmission condition may include the elapse of a predetermined time after the transmission of the second synchronization message FU, or may include the elapse of a predetermined time after a plurality of transmissions of the second synchronization message FU. Moreover, the second transmission condition may include a specific condition to be described later.

The bridge ECU 20 transmits the bridge record notification message BM to the time verification ECU 40 at the timing when a preset third transmission condition is satisfied. The third transmission condition may include the elapse of a predetermined time after the transfer of the second synchronization message FU, or may include the elapse of a predetermined time after a plurality of transfers of the second synchronization message FU. Moreover, the third transmission condition may include a specific condition to be described later.

The slave ECU 30 transmits the slave record notification message SM to the time verification ECU 40 via the bridge ECU 20 at the timing when a preset fourth transmission condition is satisfied. The fourth transmission condition may include the elapse of a predetermined time after the reception of the second synchronization message FU, or may include the elapse of a predetermined time after a plurality of receptions of the second synchronization message FU. Moreover, the fourth transmission condition may include a specific condition to be described later.

The transmission timings of the master record notification message MM, the bridge record notification message BM, and the slave record notification message SM need to be aligned in each of the ECUs 10 to 30. For example, it is assumed that the master ECU 10 transmits the master record notification message MM a predetermined time after transmitting the second synchronization message FU twice. In this case, the bridge ECU 20 needs to transmit the bridge record notification message BM to the time verification ECU 40 a predetermined time after performing the transfer process of transferring the second synchronization message FU to every slave ECU 30 twice. The slave ECU 30 needs to transmit the slave record notification message SM a predetermined time after receiving the second synchronization message FU twice.

The master ECU 10 may transmit the first synchronization message SY or the second synchronization message FU with added information requesting time synchronization verification, thereby enabling each of the ECUs 10 to 30 to understand the need to transmit the master record notification message MM, the bridge record notification message BM, and the slave record notification message SM. Details will be described later.

The time verification ECU 40 performs a process of verifying the time using the time record information received from each of the ECUs 10 to 30, and transmits the result notification message VM including the verification result to each of the ECUs 10 to 30. Specifically, the time verification ECU 40 transmits the result notification message VM including the verification result to the bridge ECU 20. The bridge ECU 20 that has received the result notification message VM transmits the result notification messages VM-0 to VM-m to the master ECU 10 and the slave ECU 30.

### (1-4. Time Record Information)

### (1-4-1. TMTR Table)

A timesync master timing record (hereinafter, TMTR) table in which the master ECU 10 records the time record information will be described.

As illustrated in FIG. 4, the TMTR table records a sequence identifier SID, a transmission source port identifier PID, a local transmission time MLT, and a global transmission time OT.

The sequence identifier SID is an identifier of a sequence used by the master ECU 10 to transmit a time synchronization message, and its value increases one by one each time the master ECU 10 transmits the first synchronization message SY.

The transmission source port identifier PID is an identifier of a port used by the master ECU 10 to transmit a time synchronization message, and a fixed value is used.

The local transmission time MLT is a time stamp representing the transmission time of the first synchronization message SY and is time information represented by the master local time.

The global transmission time OT is a time stamp representing the transmission time of the first synchronization message SY and is time information represented by the global time. The global transmission time OT is calculated based on the local transmission time MLT using an equation for converting the master local time into the global time.

### (1-4-2. TSTR Table)

A timesync slave timing record (hereinafter, TSTR) table in which the bridge ECU 20 and each slave ECU 30 record the time record information will be described.

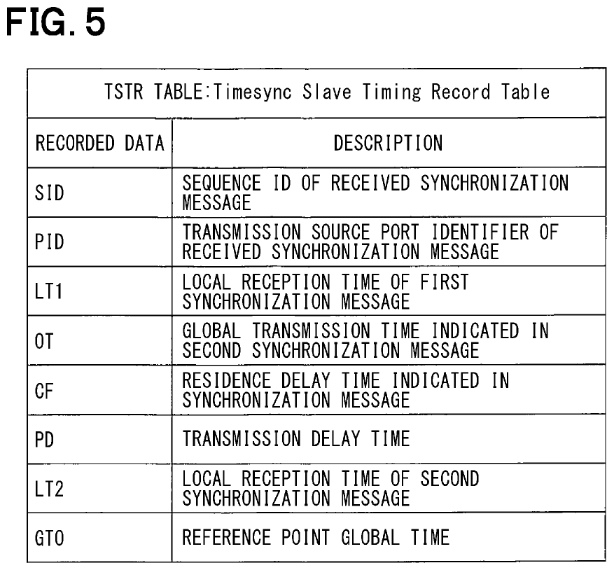

As illustrated in FIG. 5, the sequence identifier SID, the transmission source port identifier PID, the first local reception time LT1, the global transmission time OT, the residence delay time CF, the transmission delay time PD, the second local reception time LT2, and the reference global time GT0 are recorded in the TSTR table.

The sequence identifier SID, the transmission source port identifier PID, and the residence delay time CF are information extracted from the received first synchronization message SY.

As illustrated in FIG. 6, the first local reception time LT1 is a time stamp representing the reception time of the first synchronization message SY and is time information represented by the slave local time.

The first local reception time LT2 is a time stamp representing the reception time of the second synchronization message FU and is time information represented by the slave local time.

The global transmission time OT is information extracted from the received second synchronization message FU.

The transmission delay time PD is a value obtained by measurement performed separately. However, in the bridge ECU 20, the MB delay time, which is the transmission delay time between the master ECU 10 and the bridge ECU 20, is used as the transmission delay time PD. In the slave ECU 30, a total value of the SB delay time, which is the transmission delay time between the bridge ECU 20 and the slave ECU 30, and the MB delay time is used as the transmission delay time PD.

The reference global time GT0 is time information obtained by using the reception timing of the second synchronization message FU as a reference point and calculating the global time of the reference point using Equation (2). (n) attached to the parameter indicates a value obtained in the n-th sequence.

$$\begin{matrix}( Mathematical Formula 2 ) & \\ GT 0 ( n ) = OT ( n ) + CF ( n ) + PD ( n ) + \{ LT 2 ( n ) - LT 1 ( n ) \} & ( 2 )\end{matrix}$$

### (1-4-3. STBR Table)

A synchronized time base record (hereinafter, STBR) table in which the bridge ECU 20 and each slave ECU 30 record information and the like calculated from the record content of the TSTR table will be described.

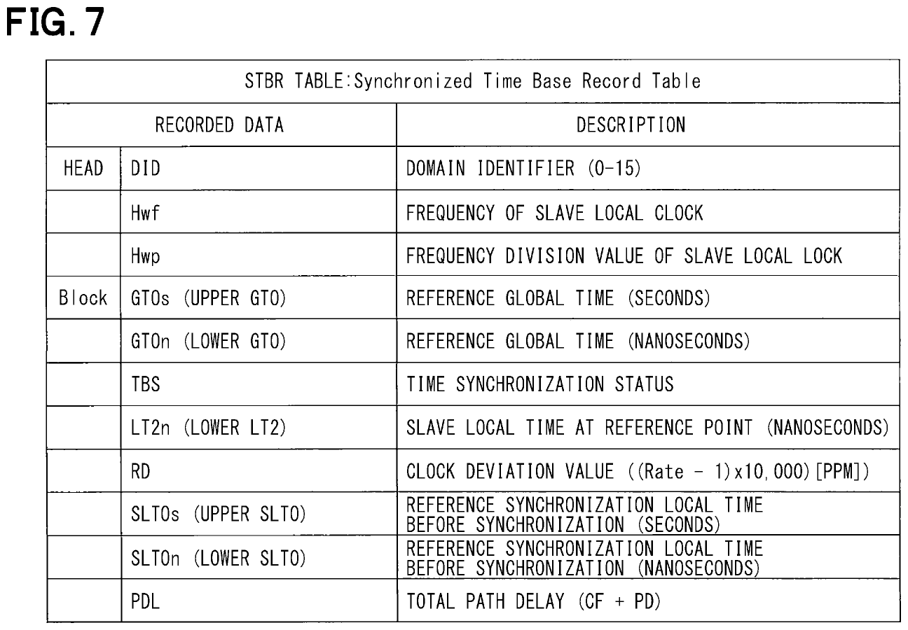

As illustrated in FIG. 7, a domain identifier DID, a clock frequency Hwf, a clock frequency division number Hwp, a reference global time GT0, a time synchronization status TBS, a local time LT2n, a clock deviation value RD, a reference synchronization local time SLT0 before synchronization, and a total path delay PDL are recorded in the STBR table.

The domain identifier DID is an identifier that is assigned in accordance with the network structure of the time synchronization system 1, and a fixed value is used as the domain identifier DID.

The clock frequency Hwf is the frequency of the local clock, and a fixed value is used.

The clock frequency division number Hwp is the frequency division number of the local clock necessary for generating the unit time of the slave local time, and a fixed value is used.

The reference global time GT0 is the same as that recorded in the TSTR table. However, the reference global time GT0 is divided into two and recorded with the upper 32 bits represented in seconds as GTOs and the lower 32 bits represented in nanoseconds as GT0n.

The local time LT2n is lower 32 bits represented in nanoseconds in the second local reception time LT2.

The reference synchronization local time SLT0 is time information obtained by calculating the synchronization local time SLT at the reference point using Equation (3). At the reference point, the synchronization local time SLT is synchronized with the global time GT. However, a reference synchronization local time SLT0(n) is a value before synchronization, and a reference synchronized local time SLT(n−1) is a value after synchronization. The same applies to the following equations (5) and (6).

$$\begin{matrix}( Mathematical Formula 3 ) & \\ SLT 0 ( n ) = SLT 0 ( n - 1 ) + Rate ( n ) \times \{ LT 2 ( n ) - LT 2 ( n - 1 ) \} & ( 3 )\end{matrix}$$

Similarly to the reference global time GT0, the reference synchronization local time SLT0 is divided into two and recorded with the upper 32 bits represented in seconds as SLT0s and the lower 32 bits represented in nanoseconds as SLT0n.

The clock deviation RD is expressed by Equation (4). The clock deviation RD is obtained by modifying the time deviation TD expressed by Equation (5). The time deviation TD is a time difference between the global time and the synchronization local time, generated from the reference point in the previous sequence to the reference point in the current sequence. The clock deviation RD expressed by Equation (4) is a value obtained by dividing the right side of Equation (5) by the second term on the right side of Equation (5) (i.e., the time interval between the reference points represented by the synchronization local time), and then converting the result into PPM units. That is, Rate is a rate correction value used in Equation (1) described in the time synchronization, and is expressed by Equation (6). That is, the rate correction value Rate is a value obtained by dividing the first term on the right side of Equation (5) (i.e., the time interval between the reference points represented by the global time) by the second term on the right side of Equation (5).

$$\begin{matrix}( Mathematical Formula 4 ) & \\ RD ( n ) = \{ Rate ( n ) - 1 \} \times {10}^{6} & ( 4 )\end{matrix}$$

$$TD ( n ) = \{ GT 0 ( n ) - GT 0 ( n - 1 ) \} - \{ SLT 0 ( n ) - SLT 0 ( n - 1 ) \} \qquad ( 5 )$$

$$Rate ( n ) = \{ GT 0 ( n ) - GT 0 ( n - 1 ) \} / \{ SLT 0 ( n ) - SLT 0 ( n - 1 ) \} \qquad ( 6 )$$

The total path delay PDL is the sum of delays required from when the message is transmitted by the master ECU 10 to when the message is received by the bridge ECU 20 or the slave ECU 30, and is expressed by Equation (7).

$$\begin{matrix}( Mathematical Formula 5 ) & \\ PDL ( n ) = CF ( n ) + PD ( n ) & ( 7 )\end{matrix}$$

The time synchronization status TBS includes a timeout flag, a synchronization history flag, an advance determination flag, and a delay determination flag. The timeout flag is a flag that is set to ON when the reception interval of the first synchronization message SY is within the allowable time. The synchronization history flag is a flag that is set to ON when synchronization with the global time has been performed by receiving the first synchronization message SY or the like.

The advance determination flag is a flag that is set to ON when a time offset OF (n) calculated by Equation (8) is OF (n)<-TH with respect to a time threshold TH, that is, when the advance of the synchronization local time with respect to the global time exceeds an allowable value. GT0 is calculated in accordance with Equation (2), and SLT0 uses a value calculated in accordance with Equation (3).

$$\begin{matrix}( Mathematical Formula 6 ) & \\ OF ( n ) = GT 0 ( n ) - SLT 0 ( n ) & ( 8 )\end{matrix}$$

The delay determination flag is set to ON when the time offset OF (n) satisfies TD (n)>TH with respect to the time threshold TH, that is, when the delay of the synchronization local time with respect to the global time exceeds an allowable value.

The advance determination flag and the delay determination flag may be set based on the time deviation TD (n) or the rate correction value Rate calculated by Equation (5).

### (1-4-4. VD Table)

A validation data (hereinafter, VD) table in which the time verification ECU 40 records a verification result will be described. The VD table is individually generated for the bridge ECU 20 and each of the plurality of slave ECUs 30.

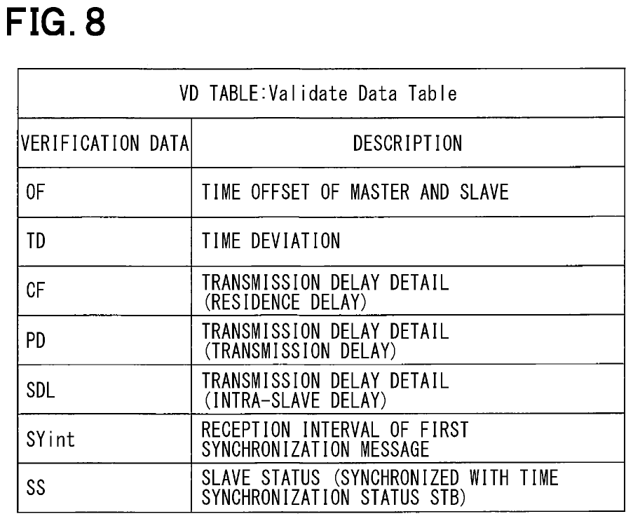

As illustrated in FIG. 8, the VD table includes a time offset OF, a clock deviation RD, a residence delay time CF, a transmission delay time PD, an intra-slave delay time SDL, a first synchronization message reception interval SYint, and a slave status SS.

Hereinafter, the time record information included in the master record notification message MM is referred to as master record information, and the time record information included in the bridge record notification message BM and the slave record notification message SM is referred to as slave record information.

The time offset OF is calculated in accordance with Equation (8). However, GT0 is calculated in accordance with Equation (9) using: OT included in the master record information acquired in the current sequence; and CF, PD, RD, LT1, and LT2 included in the slave record information acquired in the current sequence. However, Rate is calculated in accordance with Equation (10) using RD.

$$\begin{matrix}( Mathematical Formula 7 ) & \\ GT 0 ( n ) = OT ( n ) + CF ( n ) + PD ( n ) + Rate ( n ) \times \{ LT 2 ( n ) - LT 1 ( n ) \} & ( 9 )\end{matrix}$$

$$Rate ( n ) = RD ( n ) / {10}^{6} + 1 \qquad ( 10 )$$

SLT0 is calculated in accordance with Equation (11) using: SLT0 and LT2 included in the slave record information acquired in the previous sequence; and the RD and LT2 included in the slave record information acquired in the current sequence. However, Rate is calculated in accordance with Equation (10) using RD.

$$\begin{matrix}( Mathematical Formula 8 ) & \\ SLT 0 ( n ) = SLT 0 ( n - 1 ) + Rate ( n ) \times \{ LT 2 ( n ) - LT 2 ( n - 1 ) \} & ( 11 )\end{matrix}$$

The time deviation TD is calculated in accordance with Equation (12) using GT0 and SLT0 from the current sequence and GT0 and SLT0 from the previous sequence, as calculated using Equations (9) and (11).

$$\begin{matrix}( Mathematical Formula 9 ) & \\ TD ( n ) = \{ GT 0 ( n ) - GT 0 ( n - 1 ) \} - \{ SLT 0 ( n ) - SLT 0 ( n - 1 ) \} & ( 12 )\end{matrix}$$

CF and PD included in the slave record information acquired in the current sequence are recorded as the residence delay time CF and the transmission delay time PD.

The intra-slave delay SDL is calculated in accordance with Equation (13) using LT1 and LT2 included in the slave record information acquired in the current sequence.

$$\begin{matrix}( Mathematical Formula 10 ) & \\ SDL ( n ) = LT 2 ( n ) - LT 1 ( n ) & ( 13 )\end{matrix}$$

The message reception interval SYint is calculated in accordance with Equation (14) using: LT1 included in the slave record information acquired in the current sequence; and LT1 included in the slave record information acquired in the sequence.

$$\begin{matrix}( Mathematical Formula 11 ) & \\ SYint ( n ) = LT 1 ( n ) - LT 1 ( n - 1 ) & ( 14 )\end{matrix}$$

The message reception interval SYint may be the average value of the reception intervals calculated in a plurality of past sequences.

The slave status SS is similar to the time synchronization status TBS determined by the bridge ECU 20 and each slave ECU. A result of a determination process similar to that in the case of the time synchronization status TBS, executed using information included in the record information, is recorded.

As illustrated in FIG. 17, the time record information recorded in the TMTR table is transmitted from the master ECU 10 to the time verification ECU 40 through the master record notification message MM. The time record information recorded in each of the TSTR table and the STBR table is transmitted from the bridge ECU 20 or the slave ECU to the time verification ECU 40 through the bridge record notification message BM or the slave record notification message SM. The verification result recorded in the VD table is transmitted from the time verification ECU 40 to each of the ECUs 10 to 30 through the result notification message VM.

### (1-5. Processes)

### (1-5-1. Master ECU)

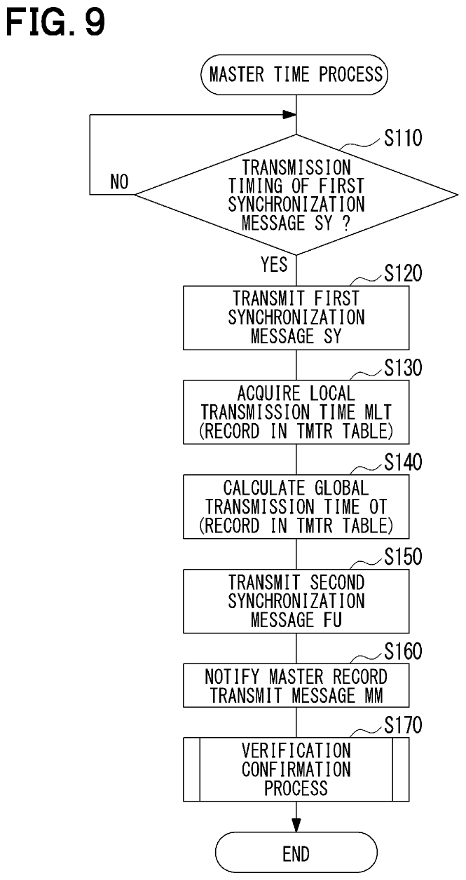

A master time process executed by the master ECU 10 for the time synchronization and time verification will be described with reference to a flowchart in FIG. 9.

The master time process is repeatedly executed when the system is activated.

In step (hereinafter, S) 110, the master ECU 10 determines whether or not it is the transmission timing of the first synchronization message SY. When it is the transmission timing, the process proceeds to S120, and when it is not the transmission timing, this step is repeated for standby. The transmission timing of the first synchronization message SY may be controlled by the master ECU 10 based on a verification result to be described later.

In S120, the master ECU 10 generates and transmits the first synchronization message SY. The first synchronization message SY includes a sequence identification (ID) and a transmission source port ID. The value of the sequence ID is incremented each time the first synchronization message SY is transmitted.

In subsequent S130, the master ECU 10 acquires the local transmission time MLT representing the transmission time of the first synchronization message SY according to the master local time. The master ECU 10 records the acquired local transmission time MLT in the TMTR table together with the sequence identifier SID and the transmission source port identifier PID to be written in the first synchronization message SY.

In subsequent S140, the master ECU 10 converts the local transmission time MLT into the global transmission time OT represented by the global time and records the global transmission time OT in the TMTR table.

In subsequent S150, the master ECU 10 generates and transmits the second synchronization message FU. The second synchronization message FU includes the global transmission time OT.

In subsequent S160, the master ECU 10 generates the master record notification message MM and transmits the master record notification message MM to the time verification ECU 40. The master record notification message MM may include all the information recorded in the TMTR table as the time record information.

In subsequent S170, the master ECU 10 executes a verification confirmation process and terminates the master time process.

Here, the verification confirmation process executed by the master ECU 10 in S170 will be described with reference to the flowchart of FIG. 18.

Upon the start of the verification confirmation process, in S210, the master ECU 10 determines whether or not the result notification message VM has been received. When the result notification message VM has been received, the process proceeds to S230, and when not received, the process proceeds to S220.

In S220, the master ECU 10 determines whether or not the allowable reply time has elapsed since the transmission of the master record notification message MM. When the allowable reply time has not elapsed, the process returns to S210, and when the allowable reply time has elapsed, the process proceeds to S240.

In S230, the master ECU 10 checks the content of the result notification message VM and determines whether or not the synchronization state is normal. When the synchronization state is normal, the process is terminated, and when there is an anomaly, the process proceeds to S240. The result notification message VM may include all the information recorded in the VD table by the time verification ECU 40.

In S240, the master ECU 10 performs a process of addressing the anomaly and terminates the process. For example, the transmission of the first synchronization message SY, the second synchronization message FU, and the master record notification message MM may be stopped as the process of addressing the anomaly.

### (1-5-2. Bridge ECU)

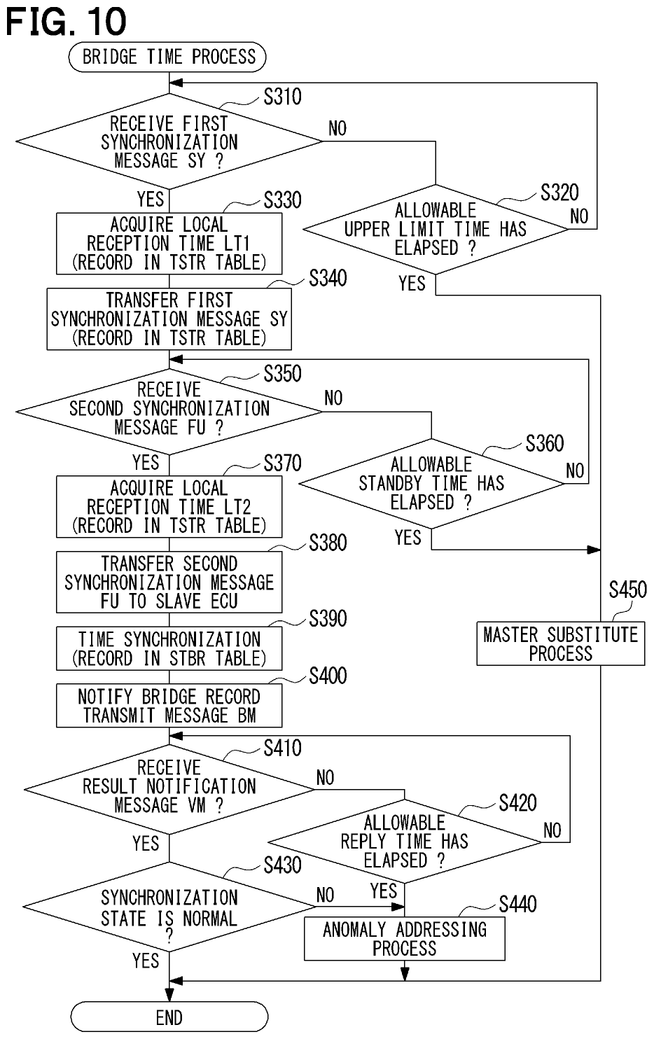

A bridge time process executed by the bridge ECU 20 for the time synchronization and time verification will be described with reference to a flowchart of FIG. 10.

The bridge time process is repeatedly executed when the system is activated.

In S310, the bridge ECU 20 determines whether or not the first synchronization message SY has been received. When the first synchronization message SY has been received, the process proceeds to S330, and when not received, the process proceeds to S320.

In S320, the bridge ECU 20 determines whether or not the allowable upper limit time has elapsed since the previous reception of the first synchronization message SY. When the allowable upper limit time has elapsed, the process proceeds to S450, and when the allowable upper limit time has not elapsed, the process returns to S310.

In S330, the bridge ECU 20 acquires the first local reception time LT1 representing the reception time of the first synchronization message SY according to the slave local time. The bridge ECU 20 records the acquired first local reception time LT1 in the TSTR table together with the sequence identifier SID and the transmission source port identifier PID extracted from the first synchronization message SY.

In subsequent S340, the bridge ECU 20 measures the residence delay time CF of the first synchronization message SY in the bridge ECU 20, adds the measured residence delay time CF to the first synchronization message SY, and transfers the first synchronization message SY to each slave ECU 30. In addition, the bridge ECU 20 records the residence delay time CF in the TSTR table.

In subsequent S350, the bridge ECU 20 determines whether or not the second synchronization message FU has been received. When the second synchronization message FU has been received, the process proceeds to S370, and when not received, the process proceeds to S360.

In S360, the bridge ECU 20 determines whether or not the allowable standby time has elapsed since the reception of the first synchronization message SY. When the allowable standby time has elapsed, the process proceeds to S450, and when the allowable standby time has not elapsed, the process returns to S350.

In S370, the bridge ECU 20 acquires the second local reception time LT2 representing the reception time of the second synchronization message FU according to the slave local time. The bridge ECU 20 records the acquired second local reception time LT2 in the TSTR table together with the global transmission time OT extracted from the second synchronization message FU.

In subsequent S380, the bridge ECU 20 transfers the second synchronization message FU to each slave ECU 30.

In subsequent S390, the bridge ECU 20 executes time synchronization and recording in the STBR table based on the contents recorded in the TSTR table. The bridge ECU 20 performs time synchronization by updating the reference global time GT0 and the rate correction value Rate used for calculating the synchronization local time according to Equation (1). The bridge ECU 20 calculates the reference global time GT0, the reference synchronization local time SLT0, the slave local time LT2n of the reference point, the clock deviation RD, and the total path delay PDL, determines the time synchronization status TBS, and records the calculation result and the determination result in the STBR table.

In subsequent S400, the bridge ECU 20 generates the bridge record notification message BM and transmits the bridge record notification message BM to the time verification ECU 40. The bridge record notification message BM may include all information recorded in the TSTR table and the STBR table as the time record information.

In subsequent S410, the bridge ECU 20 determines whether or not the result notification message VM has been received. When the result notification message VM has been received, the process proceeds to S430, and when not received, the process proceeds to S420. The result notification message VM may include all the information recorded in the VD table by the time verification ECU 40.

In S420, the bridge ECU 20 determines whether or not the allowable reply time has elapsed since the transmission of the bridge record notification message BM. When the allowable reply time has not elapsed, the process returns to S410, and when the allowable reply time has elapsed, the process proceeds to S440.

In S430, the bridge ECU 20 checks the content of the result notification message VM and determines whether or not the synchronization state is normal. When the synchronization state is normal, the process is terminated, and when the synchronization state is anomalous, the process proceeds to S440.

In S440, the bridge ECU 20 executes a process of addressing the anomaly of the time synchronization and terminates the process. As the process of addressing the anomaly, for example, the process related to the time synchronization may be stopped.

In S450, the bridge ECU 20 determines that there is an anomaly in the master ECU 10, and executes a substitute process of transmitting the first synchronization message SY and the second synchronization message FU instead of the master ECU 10. In the substitute process, the synchronization local time of the bridge ECU 20 is regarded as the global time, and a process similar to the main time process in the master ECU 10 is executed.

### (1-5-3. Slave ECU)

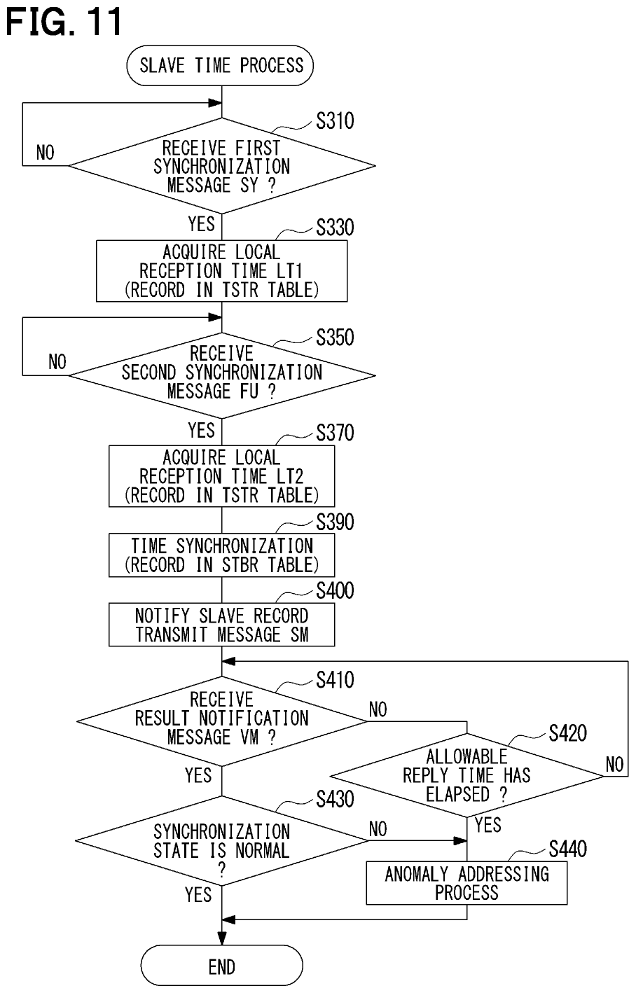

A slave time process executed by the slave ECU 30 for the time synchronization and time verification will be described with reference to a flowchart in FIG. 11.

The slave time process is repeatedly executed when the system is activated.

In the slave time process, S320, S340, S360, S380, and S450 are omitted from the bridge time process.

In S310, when the first synchronization message SY has not been received, the slave ECU 30 repeats this step to stand by. When the first synchronization message SY is received, the slave ECU 30 proceeds the process to S330. The process content of S330 is similar to that of S330 in the bridge time process described above. After executing the process of S330, the slave ECU 30 proceeds the process to S350.

In S350, when the second synchronization message FU has not been received, the slave ECU 30 repeats this step to stand by. When receiving the second synchronization message FU, the slave ECU 30 proceeds the process to S370. The process content of S370 is similar to that of S330 in the bridge time process described above. After executing the process of S370, the slave ECU 30 proceeds the process to S390. The process content of S390 is similar to that of S390 in the bridge time process described above. After executing the process of S390, the slave ECU 30 proceeds the process to S400.

In S400, the slave ECU 30 transmits the slave record notification message SM instead of the bridge record notification message BM. However, the content of the slave record notification message SM is similar to that of the bridge record notification message BM. The process contents of steps S410, S420, S430, and S440, which are steps after S400, are similar to those of S410, S420, S430, and S440 in the bridge time process described above.

### (1-5-4. Time Verification ECU)

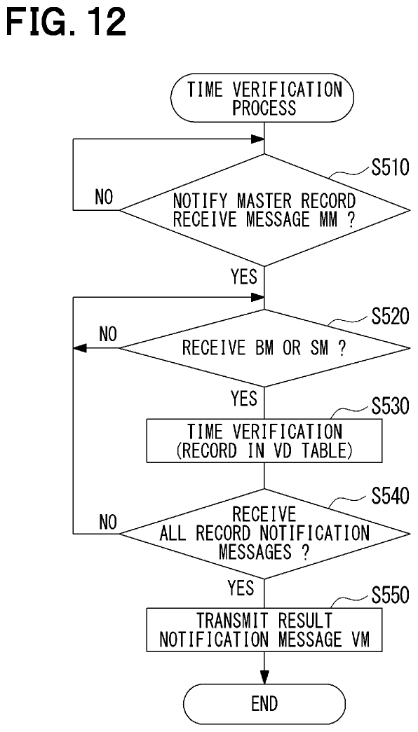

A time verification process executed by the time verification ECU will be described with reference to a flowchart of FIG. 12.

The time verification process is repeatedly executed when the system is activated.

In S510, the time verification ECU 40 determines whether or not the master record notification message MM has been received. When the master record notification message MM has been received, the process proceeds to S520, and when not received, this step is repeated for standby.

In S520, the time verification ECU 40 determines whether or not the bridge record notification message BM or the slave record notification message SM has been received. When the bridge record notification message BM or the slave record notification message SM has been received, the process proceeds to S530, and when not received, this step is repeated for standby.

In S530, the time verification ECU 40 executes the time verification of the verification target ECU using the transmission source of the received bridge record notification message BM or slave record notification message SM as the verification target ECU, and records the verification result in the VD table. That is, the synchronization state of the synchronization local time of each of the ECUs 20, 30 with respect to the global time is verified based on the global transmission time OT acquired from the master ECU 10 and the time record type information acquired from each of the ECUs 20, 30 to be verified.

In subsequent S540, the time verification ECU 40 determines whether or not the time verification has been completed for all of the bridge ECU 20 and the plurality of slave ECUs 30. When the time verification has been completed, the process proceeds to S550, and when not completed, the process returns to S520.

In S550, the time verification ECU generates and transmits the result notification message VM and terminates the process. The result notification message VM may include all the information recorded in the VR table prepared for the bridge ECU 20 and each of the plurality of slave ECUs 30.

The bridge ECU 20 transfers the result notification message VM received from the time verification ECU 40 to the master ECU 10 and each of the plurality of slave ECUs 30.

### (1-6. Operation Example in Anomalous State)

In the normal state, the bridge ECU 20 repeatedly receives the first synchronization message SY at intervals within the allowable upper limit time. However, when the allowable upper limit time elapsed and the first synchronization message SY could not be received (i.e., in the case of S320—YES), it is determined that an anomaly has occurred in the master ECU 10, and a master substitute process is executed. The master substitute process is a process in which the bridge ECU 20 transmits the first synchronization message SY and the second synchronization message FU instead of the master ECU 10. The allowable upper limit time may be changed based on the control of the transmission timing by the master ECU 10.

When the second synchronization message FU could not be received within the allowable standby time after the reception of the first synchronization message SY (i.e., in the case of S360—YES), the bridge ECU 20 determines that an anomaly has occurred in the master ECU 10 and executes the master substitute process.

The execution of the master substitute process by the bridge ECU 20 enables the continuation of the process requiring time synchronization, even if an anomaly occurs in the master ECU 10.

When the master record notification message MM could not be received, even if the bridge record notification message BM or the slave record notification message SM was received, the time verification ECU 40 cannot perform time verification and thus does not transmit the result notification message VM.

When any of the ECUs 10 to 30 having transmitted the record notification messages MM, BM, SM cannot receive the result notification message VM even after the elapse of the allowable reply time, it is possible to recognize that some anomaly has occurred and address the anomaly.

Each of the ECUs 10 to 30 having received the result notification message VM can check the time synchronization state from the content of the verification result indicated in the result notification message VM, and when there is an anomaly in the time synchronization state, the anomaly can be addressed.

### (1-7. Effects)

According to the first embodiment described in detail above, the following effects are obtained.
(1a) The time synchronization system 1 transmits the time record information of each of the ECUs 10 to 30 to the time verification ECU 40. The time verification ECU 40 calculates verification information related to time synchronization based on the time record information received from the master ECU 10 and the time record information received from the bridge ECU 20 and each of the plurality of slave ECUs 30. The time verification ECU 40 transmits information regarding the calculated time synchronization to each of the ECUs 10 to 30 through the result notification message VM. Each of the ECUs 10 to 30 can rapidly determine the time synchronization state by comparing the information indicated in the result notification message VM with the information regarding the time synchronization calculated by each of the ECUs 10 to 30.

### (1-8. Correspondence of Terms)

In the first embodiment, the master ECU 10 corresponds to a master device in the present disclosure, the bridge ECU 20 and the plurality of slave ECUs 30 correspond to slave devices in the present disclosure, and the time verification ECU 40 corresponds to a time verification device in the present disclosure. The time record information recorded in the TMTR table and transmitted through the master record notification message MM corresponds to master verification information in the present disclosure. The time record information recorded in the TSTR table and the STBR table and transmitted through the bridge record notification message BM and the slave record notification message SM corresponds to slave verification information. The information recorded in the VD table and transmitted through the result notification message VM corresponds to a verification information. S120 and S150 correspond to a synchronization message transmission unit in the present disclosure, and S160 corresponds to a master information transmission unit in the present disclosure. S390 corresponds to a synchronization execution unit in the present disclosure, and S400 corresponds to a slave information transmission unit in the present disclosure. S530 corresponds to a verification execution unit in the present disclosure, and S550 corresponds to a result transmission unit in the present disclosure. S230 in FIGS. 18 and S430 in FIGS. 10 and 11 correspond to an anomaly determination unit in the present disclosure.

### 2. Second Embodiment

(2-1. Difference from First Embodiment)

The basic configuration of a second embodiment is similar to that of the first embodiment, and therefore the difference will be described below. The same reference numerals as those in the first embodiment denote the same configuration, and the preceding description will be referred to.

In the first embodiment described above, the master ECU 10 is configured to periodically transmit the first synchronization message SY to the bridge ECU 20. The second embodiment differs from the first embodiment in that the transmission timing is changed by changing the transmission interval of the first synchronization message SY based on the result of time synchronization verification.

The second embodiment is similar to the first embodiment except that the content of the verification confirmation process executed in S170 in the master time process is partially different.

### (2-2. Process)

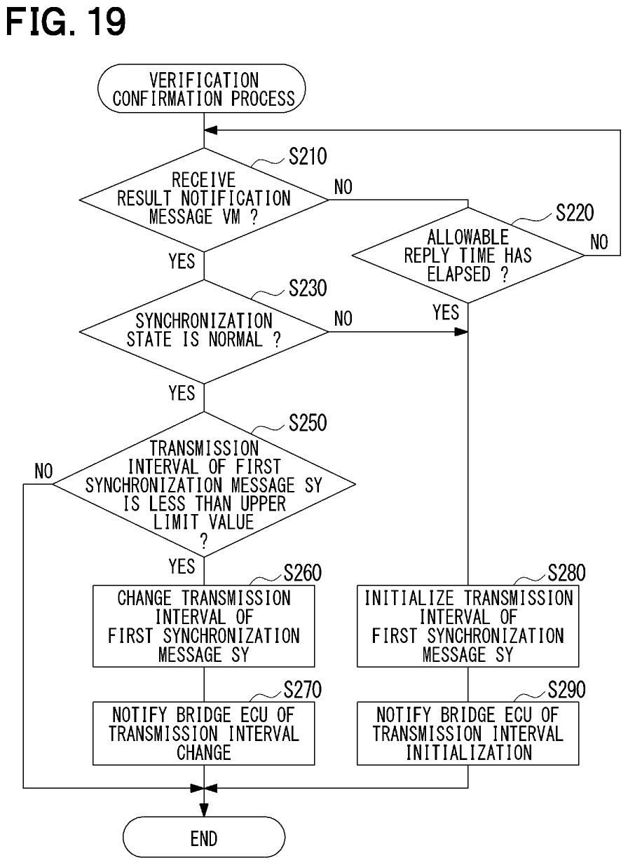

The verification confirmation process executed by the master ECU 10 according to the second embodiment will be described with reference to a flowchart of FIG. 19. The processes of S210 to S230 is similar to the case of the first embodiment.

However, when making an affirmative determination in S230, the master ECU 10 proceeds the process to S250. When making an affirmative determination in S220 or a negative determination in S230, the master ECU 10 proceeds the process to S280.

In S250, the master ECU 10 determines whether or not the transmission interval of the first synchronization message SY is less than the upper limit value. When the transmission interval is less than the upper limit value, the process proceeds to S260, and when the transmission interval is equal to or greater than the predetermined value, the verification confirmation process is terminated.

In S260, the master ECU 10 performs control to change the transmission interval of the first synchronization message SY. Specifically, the transmission interval is changed to be longer than the transmission interval of the current first synchronization message SY.

In subsequent S270, the master ECU 10 notifies the bridge ECU 20 that the transmission interval of the first synchronization message SY has been changed, and terminates the verification confirmation process.

In S280, the master ECU 10 initializes the transmission interval of the first synchronization message SY. Specifically, the transmission interval is set to an initial value, which is the shortest value among the selectable setting values of the transmission interval.

In subsequent S290, the master ECU 10 notifies the bridge ECU 20 that the transmission interval of the first synchronization message SY has been returned to the initial value, and terminates the verification confirmation process. The processes of S280 and S290 are an example of the anomaly addressing process illustrated in S240 of FIG. 18.

In previous S260, the master ECU 10 may change the transmission interval of the first synchronization message SY, for example, by adding a predetermined value to the current value of the transmission interval each time S260 is executed. In S260, the master ECU 10 may count the number of times the verification result has been continuously determined to be normal in previous S230 (hereinafter, the number of normal times), and change the transmission interval to the one associated in advance with the number of normal times. Specifically, for example, the transmission interval of the first synchronization message SY may be changed when the number of normal times of verification results reaches 5, 15, and 30. In this case, the transmission interval when the number of normal times of verification results is 30 or more is set to be longer than the transmission interval when the number of normal times of verification results is 15 to 29. The transmission interval when the number of normal times of verification results is 15 to 29 is set to be longer than the transmission interval when the number of normal times of verification results is 5 to 14. The transmission interval when the number of normal times of verification results is 5 to 14 is set to be longer than the transmission interval (i.e., the initial value) when the number of normal times of verification results is 0 to 4. The number of normal times as a threshold for changing the transmission interval of the first synchronization message SY is not limited to 5, 15, and 30 as described above. In addition, the length of the transmission interval of the first synchronization message SY is not limited to four patterns as described above. When the transmission interval of the first synchronization message SY is changed according to the number of normal times, each time the transmission interval of the first synchronization message SY is initialized in S280, the number of normal times is also reset to 0.

### (2-3. Effects)

According to the second embodiment described in detail above, the effect
(1a) of the first embodiment described above is obtained, and the following effect is further obtained.
(2a) According to the present embodiment, when an anomaly in the synchronization state is detected in accordance with the verification result of the time verification, the process of addressing the anomaly is executed rapidly, and the transmission interval of the first synchronization message SY is made longer as the synchronization state continues to be normal for a longer time. Therefore, an anomaly in the synchronization state (i.e., a time deviation) can be rapidly addressed, and the frequency of executing time synchronization verification is optimized according to the synchronization state, so that the process load and communication load required for time synchronization verification can be reduced.

### (2-4. Correspondence of Terms)

In the second embodiment, S230 corresponds to a synchronization state determination unit in the present disclosure, and S250 to S260 correspond to a transmission interval control unit in the present disclosure.

### 3. Third Embodiment

(3-1. Difference from First Embodiment)

The basic configuration of a third embodiment is similar to that of the first embodiment, and therefore the difference will be described below. The same reference numerals as those in the first embodiment denote the same configuration, and the preceding description will be referred to.

In the first embodiment described above, the master ECU 10 is configured to transmit the master record notification message MM each time the first synchronization message SY and the second synchronization message FU are transmitted to the bridge ECU 20. The third embodiment differs from the first embodiment in that the master record notification message MM is transmitted when a preset record transmission condition is satisfied.

The third embodiment is similar to the first embodiment except that the content of the master time process is partially different.

### (3-2. Process)

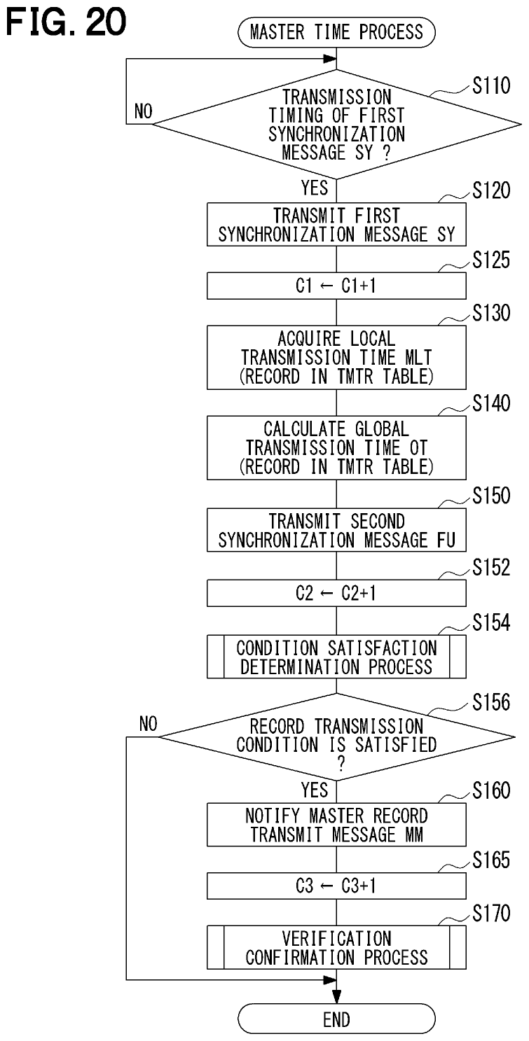

The master time process executed by the master ECU 10 according to the third embodiment will be described with reference to a flowchart in FIG. 20. The present embodiment is similar to the case of the first embodiment except that S125, S152, S154, S156, and S165 are added.

That is, when the master ECU 10 transmits the first synchronization message SY in S120, in subsequent S125, the master ECU 10 increments a first counter C1, which counts the number of transmissions of the first synchronization message SY, by 1 and advances the process to S130.

When the master ECU 10 transmits the second synchronization message FU in S150, in subsequent S152, the master ECU 10 increments a second counter C2, which counts the number of transmissions of the second synchronization message FU, by 1.

In subsequent S154, the master ECU 10 executes a condition satisfaction determination process of determining whether or not the record transmission condition has been satisfied.

In subsequent S156, the master ECU 10 determines whether or not the record transmission condition has been determined to be satisfied as a result of the condition satisfaction determination process. When the record transmission condition has been determined to be satisfied, the process proceeds to S160, and when the record transmission condition has been determined not to be satisfied, the master time process is terminated.

When the master ECU transmits the master record notification message MM in S160, in subsequent S165, the master ECU increments a third counter C3, which counts the number of transmissions of the master record notification message MM, by 1 and advances the process to S170.

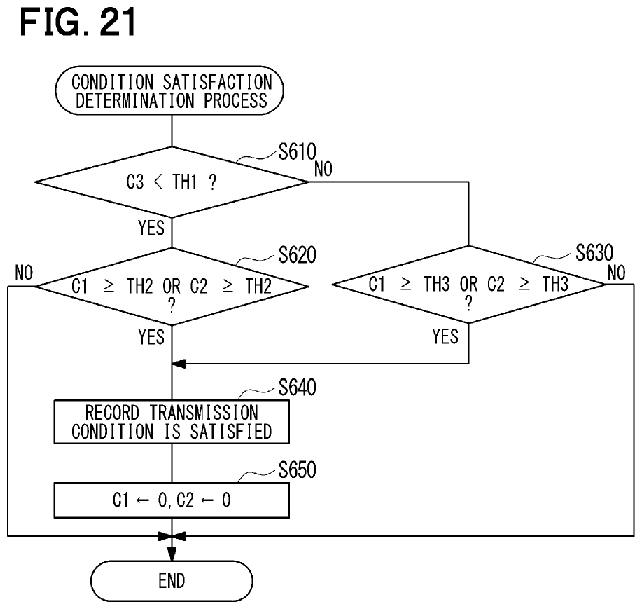

Next, the condition satisfaction determination process executed by the master ECU 10 in S154 will be described with reference to a flowchart in FIG. 21.

Upon the start of the condition satisfaction determination process, in S610, the master ECU 10 determines whether or not the third counter C3 is equal to or greater than a first threshold TH1. When the third counter C3 is less than the first threshold value TH1, the process proceeds to S620, and when the third counter C3 is equal to or greater than the first threshold TH1, the process proceeds to S630.

In S620, the master ECU 10 determines whether or not the first counter C1 or the second counter C2 is equal to or greater than a second threshold TH2. When the first counter C1 or the second counter C2 is equal to or greater than the second threshold TH2, the process proceeds to S640, and when the first counter C1 or the second counter C2 is less than the second threshold TH2, the condition satisfaction determination process is terminated.

In S630, the master ECU 10 determines whether or not the first counter C1 or the second counter C2 is equal to or greater than a third threshold TH3. When the first counter C1 or the second counter C2 is equal to or greater than the third threshold TH3, the process proceeds to S640, and when the first counter C1 or the second counter C2 is less than the third threshold TH3, the condition satisfaction determination process is terminated.

In S640, the master ECU 10 determines that the record transmission condition is satisfied.

In subsequent S650, the master ECU 10 initializes the first counter C1 and the second counter C2 to 0 and terminates the condition satisfaction determination process.

That is, while the number of transmissions of the master record notification message MM is less than TH1, the master ECU 10 transmits the master record notification message MM once each time the first synchronization message SY or the second synchronization message FU is transmitted TH2 times. After the number of transmissions of the master record notification message MM reaches TH1, the master ECU 10 transmits the master record notification message MM once each time the first synchronization message SY or the second synchronization message FU is transmitted TH3 times.

For example, when TH2<TH3, time verification is performed at a relatively high frequency after system activation, and time verification is performed at a relatively low frequency after the number of transmissions of the master record notification message MM reaches TH1.

Here, the case where the condition satisfaction determination process is executed by the master ECU 10 has been described, but the condition satisfaction determination process may be similarly applied to the bridge ECU 20 and the slave ECU 30. However, in this case, the bridge ECU 20 is configured to change the transmission timing of the bridge record notification message BM in accordance with the number of transfers of the first synchronization message SY or the second synchronization message FU and the number of transmissions of the bridge record notification message BM. The slave ECU 30 is configured to change the transmission timing of the slave record notification message SM in accordance with the number of receptions of the first synchronization message SY or the second synchronization message FU and the number of transmissions of the slave record notification message SM.

In the condition satisfaction determination process described above, the transmission interval of the master record notification message MM has been controlled in two stages by determining whether or not the third counter C3 is less than the first threshold TH1 in S610, but the present invention is not limited thereto. For example, the transmission interval of the master record notification message MM may be controlled in three or more stages by making the determination in S610 in a plurality of stages, that is, comparing the third counter C3 with a plurality of different thresholds.

### (3-3. Effects)

According to the third embodiment described in detail above, the effect (1a) of the first embodiment described above is obtained, and the following effects are further obtained.
(3a) In the present embodiment, the master record notification message MM is transmitted when the record transmission condition is satisfied, thereby controlling the transmission interval of the master record notification message MM and the frequency of executing the time verification process. Therefore, the process load required for time synchronization verification can be reduced compared to the case where the master record notification message MM is transmitted each time the second synchronization message FU is transmitted.
(3b) In the present embodiment, the record transmission condition is controlled according to the number of transmissions of the master record notification message MM. Therefore, for example, the frequency of time synchronization verification can be appropriately controlled by executing the time verification process at a relatively high frequency until the operation stabilizes after system activation, and decreasing the frequency of executing the time verification process once the operation stabilizes.

### (3-4. Modifications)

In the third embodiment, both the first counter C1 and the second counter C2 are provided, but either one of the first counter C1 or the second counter C2 may be provided.

In the third embodiment, the master ECU 10 is configured to change the frequency of transmitting the master record notification message MM according to the number of transmissions of the master record notification message MM (i.e., the third counter C3). The master ECU 10 may always transmit the master record notification message MM each time the first synchronization message SY or the second synchronization message FU is transmitted a plurality of times (e.g., twice) regardless of the number of transmissions of the master record notification message MM. In this case, in the condition satisfaction determination process illustrated in FIG. 21, the processes of S610 and S630 may be omitted.

In the third embodiment, the master record notification message MM is configured to be transmitted when the record transmission condition is satisfied. On the contrary, in the normal state, the master record notification message MM may be transmitted at a certain verification execution timing, and the transmission of the master record notification message MM may be stopped when the record stop condition is satisfied. In this case, for example, the effect of the transmission stop may be limited to the verification execution timing when the record stop condition is satisfied, and the transmission of the master record notification message MM may be resumed at the next verification execution timing.

In the third embodiment, the master ECU 10 controls the timing of performing time synchronization verification in accordance with the number of transmissions of the first synchronization message SY, the second synchronization message FU, and the master record notification message MM. The master ECU 10 may control the timing at which time synchronization verification is performed by adding verification request information for requesting to perform time synchronization verification to the first synchronization message SY or the second synchronization message FU. Specifically, when transmitting the first synchronization message SY or the second synchronization message FU with added verification request information, the master ECU 10 may determine that the record transmission condition is satisfied and transmit the master record notification message MM. When receiving the first synchronization message SY or the second synchronization message FU with added verification request information, the bridge ECU 20 or the slave ECU 30 may transmit the bridge record notification message BM and the slave record notification message SM. A 1-bit field (hereinafter, a time synchronization verification field) may be provided in the first synchronization message SY or the second synchronization message FU, and when the time synchronization verification field is “1”, the execution of time synchronization verification may be requested. When the time synchronization verification field does not exist in the first synchronization message SY or the second synchronization message FU, or when the time synchronization verification field is “0”, the execution of the time synchronization verification may not be requested.

In the third embodiment, the master ECU 10 determines the satisfaction of the record transmission condition by comparing the number of transmissions of the first synchronization message SY or the second synchronization message FU with the second threshold TH2 or the third threshold TH3. The master ECU 10 may determine that the record transmission condition is satisfied when specific conditions listed below are satisfied.

### <Specific Conditions>

When it is detected that the vehicle speed is equal to or greater than a predetermined value (e.g., 5 km/h).
When it is detected that an external device (e.g., diagnostic tool, reprogramming tool, etc.) to one of the ECUs 10 to 30 has been connected.
When it is detected that a driving assistance function or an autonomous driving function (e.g., adaptive cruise control, lane keeping assist systems, etc.) has been turned on in a driving assistance system ECU that performs driving assistance including autonomous driving as the slave ECU 30.
When it is detected that specific data (e.g., data including updated data on vehicle functions and information indicating that time synchronization is to be verified) has been received.

Each information related to the determination of the specific conditions may be directly received by the master ECU 10 from a sensor or the like that collects information, or may be indirectly received by the master ECU 10 from the slave ECU 30 that collects information from a sensor or the like via the bridge ECU 20. The information related to the determination of the specific conditions may include, for example, a vehicle speed, the connection states of the external device, the operation states of the driving assistance function and autonomous driving function, specific data, and the like.

By using such specific conditions, the frequency of time synchronization verification can be controlled more appropriately, and the load of the process in each of the ECUs 10 to 40 and the load of communication between the ECUs 10 to 40 can be reduced.

### (3-5. Correspondence of Terms)

In the third embodiment, S154 corresponds to a condition satisfaction determination unit in the present disclosure, and S610 to S620 correspond to a specified number changing unit in the present disclosure. The record transmission condition corresponds to a verification information transmission condition in the present disclosure, and each of the second threshold TH2 and the third threshold TH3 corresponds to a specified number of times in the present disclosure.

### 4. Other Embodiments

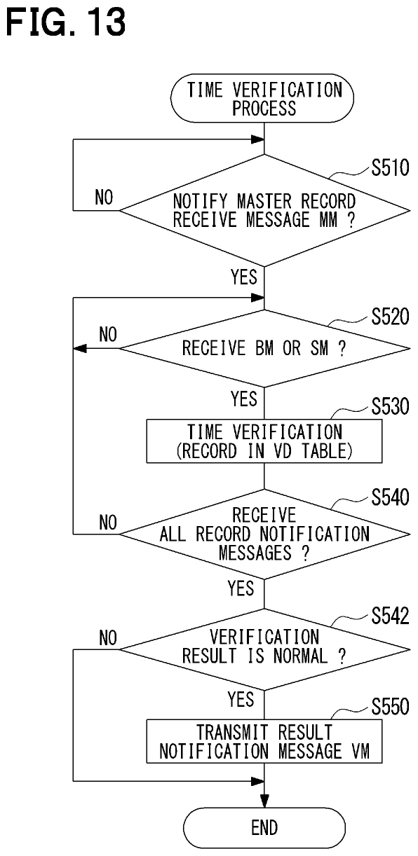

Although the embodiments of the present disclosure have been described above, the present disclosure is not limited to the above embodiments, and various modifications can be made.
(4a) In the embodiment described above, the time verification ECU 40 is configured to return the result notification message VM regardless of the content of the verification result, but may be configured not to transmit the result notification message VM when an anomaly in time synchronization is detected from the verification result. In this case, the time verification process may be changed as illustrated in the flowchart of FIG. 13. The difference from the flowchart of FIG. 12 will be described below.

That is, when making an affirmative determination in S540, the time verification ECU 40 determines whether or not the time synchronization state is normal from the verification result in S542. When determining that the time synchronization state is normal, the time verification ECU 40 proceeds the process to S550, transmits the result notification message VM, and terminates the process. When determining that there is an anomaly in the time synchronization state, the time verification ECU 40 terminates the process without transmitting the result notification message VM.

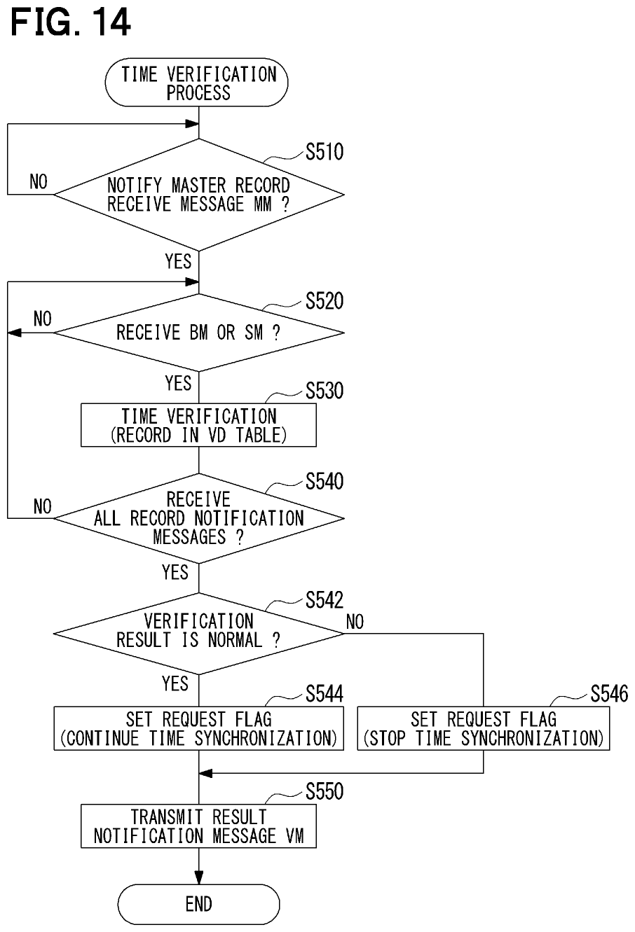

When receiving no reply of the result notification message VM within the response allowable time after the transmission of the record notification messages MM, BM, SM, each of the ECUs 10 to 30 can determine that there is an anomaly in the time synchronization state and execute a process of addressing the anomaly. S542 in FIG. 13 corresponds to a transmission prohibition unit in the present disclosure.
(4b) In the embodiment described above, the time verification ECU 40 transmits the information recorded in the VR table as the verification result through the result notification message VM, but may further add a request flag for requesting the continuation or stop of time synchronization. In this case, the time verification process may be changed as in the flowchart illustrated in FIG. 14. The difference from the flowchart of FIG. 12 will be described below.

That is, when making an affirmative determination in S540, the time verification ECU 40 determines whether or not the time synchronization state is normal from the verification result in S542. When the time synchronization state is normal, the process proceeds to S544, and when there is an anomaly, the process proceeds to S546.

In S544, the time verification ECU 40 adds a request flag indicating the continuation of time synchronization to the result notification message VM and advances the process to S550.

In S546, the time verification ECU 40 adds a request flag indicating the stop of time synchronization to the result notification message VM and advances the process to 550.

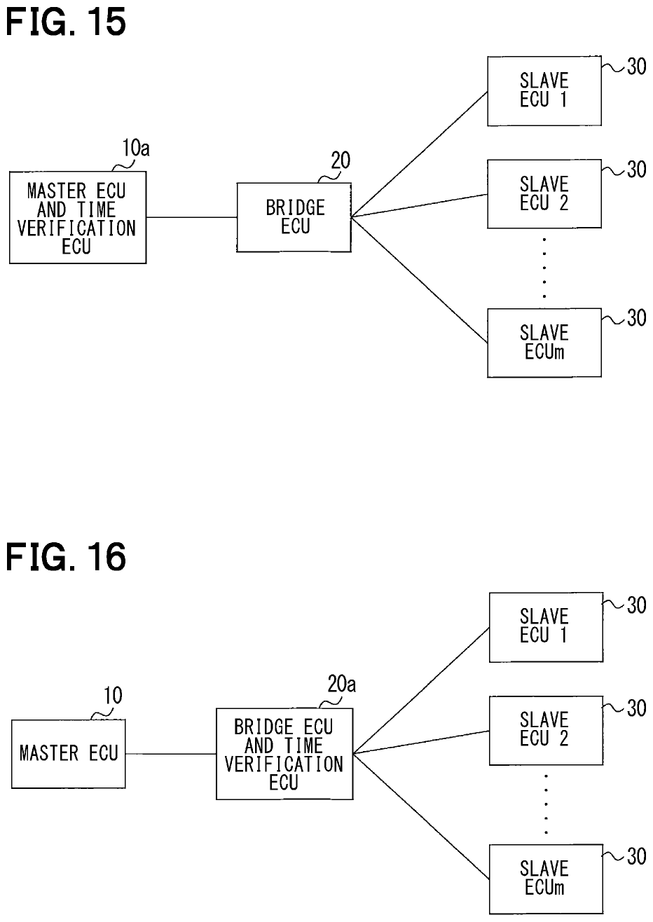

Each of the ECUs 10 to 30 continues or stops the time synchronization in accordance with the request flag added to the result notification message VM. S542 to S546 in FIG. 14 correspond to an information addition unit in the present disclosure.
(4c) In the embodiment described above, the result notification message VM including the verification result of each of the ECUs 20, 30 is transmitted simultaneously by broadcast, but may be transmitted individually to each of the ECUs 10 to 30. When the result notification message VM is transmitted individually, only the verification result related to the ECU, which is its transmission destination, may be transmitted.
(4d) In the embodiment described above, the external device interface 50 to which the external diagnostic tool 60 is connected is connected to the bridge ECU 20, but the external device interface 50 may be connected to the master ECU 10 or the time verification ECU 40. The external diagnostic tool 60 may be configured to be connected to one of the master ECU 10, the bridge ECU 20, or the time verification ECU 40 via a wireless communication IF.
(4e) In the embodiment described above, the time verification ECU 40 is configured as an independent ECU. However, a bridge ECU 20a may have a function as the time verification ECU 40 as illustrated in FIG. 15, or a master ECU 10a may have the function as illustrated in FIG. 16.
(4f) In the above embodiment, the reception timing of the second synchronization message FU is used as the reference point for aligning the synchronization local time with the global time, but the reference point may be set arbitrarily.
(4g) Each of the ECUs 10 to 40 and the methods described in the present disclosure may be implemented by a dedicated computer provided by configuring a processor and memory programmed to perform one or more functions embodied by a computer program. Alternatively, each of the ECUs 10 to 40 and the methods described in the present disclosure may be implemented by a dedicated computer provided by configuring a processor with one or more dedicated hardware logic circuits. Alternatively, each of the ECUs 10 to 40 and the methods described in the present disclosure may be implemented by one or more dedicated computers configured by combinations of processors and memories programmed to perform one or more functions and processors configured by one or more hardware logic circuits. Furthermore, the computer program may be stored in a computer-readable non-transitory tangible storing medium as an instruction executed by a computer. The method for realizing the functions of the respective units included in the ECUs 10 to 40 does not necessarily need to include software, and all of the functions may be realized with the use of one or multiple hardware.
(4h) The multiple functions of one component in the above embodiments may be implemented by multiple components, or a function of one component may be implemented by multiple components. A plurality of functions belonging to a plurality of components may be achieved by one component, or one function achieved by a plurality of components may be achieved by one component. A part of the configuration of the above embodiments may be omitted as appropriate. At least a part of the configuration in one embodiment may be added to or substituted for the configuration of another embodiment.
(4i) In addition to the time synchronization system 1 and the time verification device 40 described above, the present disclosure can also be implemented in various forms, such as a program for causing a computer to function as the time verification device 40, a non-transitory tangible storage medium such as a semiconductor memory recording the program, a time verification method, or the like.

### 5. Technical Idea Disclosed in the Present Specification

### (Item 1)

A time synchronization system including:
a master device, one or more slave devices, and a time verification device connected via a communication network,
in which
the master device includes
a synchronization message transmission unit configured to repeatedly transmit to each of the one or more slave devices, a synchronization message including a transmission time indicated by a global time counted by a clock of the master device, and
a master information transmission unit configured to transmit master verification information including a transmission time of the synchronization message to the time verification device,
the slave device includes
a synchronization execution unit configured to perform time synchronization to synchronize a time indicated by a local time counted by a clock of the slave device with a time indicated by the global time, based on information obtained by receiving the synchronization message, and
a slave information transmission unit configured to transmit slave verification information including information used for time synchronization by the synchronization execution unit to the time verification device, and
the time verification device includes
a verification execution unit that generates, for each of the slave devices, verification information for verifying a synchronization state between the local time and the global time, based on the master verification information received from the master device and the slave verification information received from each of the one or more slave devices, and
a result transmission unit configured to transmit the verification information generated by the verification execution unit to each of the one or more slave devices.

### (Item 2)

The time synchronization system according to the item 1, wherein the time verification device further includes a transmission prohibition unit configured to prohibit the result transmission unit from transmitting the verification information when an anomaly in the synchronization state is detected based on the verification information, and the master device and the slave device further include an anomaly determination unit configured to determine that there is an anomaly in the synchronization state when the verification information fails to be received within an allowable time after transmission of the master verification information or the slave verification information.

### (Item 3)

The time synchronization system according to the item 1, wherein the time verification device further includes an information addition unit that determines whether the time synchronization state is normal based on the verification information, and adds additional information indicating a determination result to the verification information, and the master device and the slave device are configured to continue or stop the time synchronization in accordance with the additional information.

### (Item 4)

The time synchronization system according to any one of the items 1 to 3, further comprising an external device interface to which an external diagnostic tool that reads a verification result in the time verification device is attached and detached.

### (Item 5)

The time synchronization system according to any one of the items 1 to 4, wherein the one or more slave devices are a plurality of slave devices, one of the plurality of slave devices is set as a bridge device, and the master device and each of the other slave devices, except for the bridge device, are mutually connected via the bridge device.

### (Item 6)

The time synchronization system according to the item 5, wherein the time verification device is configured integrally with either the master device or the bridge device.

### (Item 7)

The time synchronization system according to any one of the Items 1 to 6, wherein the verification execution unit calculates, as the verification information, at least one of: a time offset that represents a difference between a reference global time, which is a time at a reference point where time alignment is performed, indicated by the global time, and a reference local time indicated by the local time; or a time deviation that is a difference between a value of a time length between reference points indicated by the global time and a value of the time length between the reference points indicated by the local time.

### (Item 8)

The time synchronization system according to any one of the items 1 to 7, wherein the master device further includes a synchronization state determination unit configured to determine whether the synchronization state is normal in accordance with the verification information received from the time verification device, and a transmission interval control unit configured to change a transmission interval of the synchronization message transmitted by the synchronization message transmission unit according to a total number of times the synchronization state is normal, in accordance with a determination result in the synchronization state determination unit.

### (Item 9)

The time synchronization system according to the item 8, in which the transmission interval control unit is configured to change the transmission interval of the synchronization message, transmitted by the synchronization message transmission unit, in accordance with the determination result of the synchronization state determination unit such that the transmission interval of the synchronization message becomes longer as the synchronization state continues to be normal.

### (Item 10)

The time synchronization system according to any one of the items 1 to 9, wherein the master information transmission unit is configured to transmit the master verification information each time the synchronization message is transmitted once or a plurality of times.

### (Item 11)

The time synchronization system according to any one of items 1 to 9, in which the master information transmission unit is configured to transmit the master verification information when information requesting execution of time synchronization verification is included in the synchronization message.

What is claimed is:

1. A time synchronization system comprising:
a master device;
one or more slave devices; and
a time verification device, which are connected via a communication network,
wherein
the master device includes
a synchronization message transmission unit configured to repeatedly transmit to each of the one or more slave devices, a synchronization message including a transmission time indicated by a global time counted by a clock of the master device, and
a master information transmission unit configured to transmit master verification information including a transmission time of the synchronization message to the time verification device,
the slave device includes
a synchronization execution unit configured to perform time synchronization to synchronize a time indicated by a local time counted by a clock of the slave device with a time indicated by the global time, based on information obtained by receiving the synchronization message, and
a slave information transmission unit configured to transmit slave verification information including information used for time synchronization by the synchronization execution unit to the time verification device, and
the time verification device includes
a verification execution unit that generates, for each of the slave devices, verification information for verifying a synchronization state between the local time and the global time, based on the master verification information received from the master device and the slave verification information received from each of the one or more slave devices, and
a result transmission unit configured to transmit the verification information generated by the verification execution unit to the master device and each of the one or more slave devices.

2. The time synchronization system according to claim 1, wherein
the time verification device further includes
a transmission prohibition unit configured to prohibit the result transmission unit from transmitting the verification information when an anomaly in the synchronization state is detected based on the verification information, and
the master device and the slave device further include
an anomaly determination unit configured to determine that there is an anomaly in the synchronization state when the verification information fails to be received within an allowable time after transmission of the master verification information or the slave verification information.

3. The time synchronization system according to claim 1, wherein
the time verification device further includes an information addition unit that determines whether a time synchronization state is normal based on the verification information, and adds additional information indicating a determination result to the verification information, and
the master device and the slave device are configured to continue or stop the time synchronization in accordance with the additional information.

4. The time synchronization system according to claim 1, further comprising
an external device interface to which an external diagnostic tool is attached and detached, the external diagnostic tool reading a verification result in the time verification device.

5. The time synchronization system according to claim 1, wherein
the one or more slave devices are a plurality of slave devices,
one of the plurality of slave devices is set as a bridge device, and
the master device and each of the slave devices, except for the bridge device, are mutually connected via the bridge device.

6. The time synchronization system according to claim 5, wherein
the time verification device is configured integrally with one of the master device or the bridge device.

7. The time synchronization system according to claim 1, wherein
the verification execution unit calculates, as the verification information, at least one of:
a time offset that represents a difference between a reference global time and a reference local time, the reference global time being a time at a reference point, where time alignment is performed, indicated by the global time, the reference local time being the time at the reference point indicated by the local time; or
a time deviation that is a difference between a value of a time length between reference points indicated by the global time and a value of the time length between the reference points indicated by the local time, the reference points each being the reference point.

8. The time synchronization system according to claim 1, wherein
the master device further includes
a synchronization state determination unit configured to determine whether the synchronization state is normal in accordance with the verification information received from the time verification device, and
a transmission interval control unit configured to change a transmission interval of the synchronization message, transmitted by the synchronization message transmission unit, according to a total number of times the synchronization state is normal, in accordance with a determination result in the synchronization state determination unit.

9. The time synchronization system according to claim 1, wherein
the master information transmission unit is configured to transmit the master verification information each time the synchronization message is transmitted once or a plurality of times.

10. The time synchronization system according to claim 1, wherein
the master device includes a condition satisfaction determination unit configured to determine whether a preset verification information transmission condition is satisfied, and
the master information transmission unit is configured to transmit the master verification information when the condition satisfaction determination unit determines that the verification information transmission condition is satisfied.

11. The time synchronization system according to claim 10, wherein
the condition satisfaction determination unit is configured to determine that the verification information transmission condition is satisfied each time the synchronization message is transmitted a specified number of times.

12. The time synchronization system according to claim 11, wherein
the master device further includes a specified number changing unit configured to change the specified number of times such that the specified number of times increases as a total number of transmissions of the master verification information increases.

13. The time synchronization system according to claim 10, wherein
the condition satisfaction determination unit is configured to determine whether the verification information transmission condition has been satisfied, using at least one of the following:
a vehicle speed is equal to or greater than a predetermined value;
an external device is connected to the time synchronization system;
a function related to driving assistance, including autonomous driving, is in an operating state; or
information requesting verification of the synchronization state has been added to the synchronization message.

14. A time verification device used in a time synchronization system that includes a master device and one or more slave devices connected via a communication network and is configured to perform time synchronization to synchronize a time indicated by a local time counted by a clock of each of the one or more slave devices with a time indicated by a global time counted by a clock of the master device, the time verification device comprising:
a verification execution unit that generates, for each of the slave devices, verification information for verifying a synchronization state between the local time and the global time, based on master verification information received from the master device and slave verification information received from each of the one or more slave devices, and
a result transmission unit configured to transmit the verification information generated by the verification execution unit to each of the one or more slave devices,
wherein
the master verification information includes a transmission time of a synchronization message indicated by the global time, and
the slave verification information is obtained by receiving the synchronization message and includes information used for the time synchronization.

15. A time verification method in a time synchronization system including a master device, one or more slave devices, and a time verification device connected via a communication network, the time verification method comprising:
the master device
repeatedly transmitting to each of the one or more slave devices, a synchronization message including a transmission time indicated by a global time counted by a clock of the master device, and
transmitting master verification information including a transmission time of the synchronization message to the time verification device;
the slave device
performing time synchronization to synchronize a time indicated by a local time counted by a clock of the slave device with a time indicated by the global time, based on information obtained by receiving the synchronization message, and
transmitting slave verification information including information used for the time synchronization to the time verification device; and
the time verification device
generating, for each of the slave devices, verification information for verifying a synchronization state between the local time and the global time, based on the master verification information received from the master device and the slave verification information received from each of the one or more slave devices, and
transmitting the verification information generated to each of the one or more slave devices.
